(19) United States
(12) Patent Application Publication
(10) Pub. No.: US 2007/0235973 A1
(43) Pub. Date: Oct. 11, 2007

(54) Heavy-pedaling bicycle

(76) Inventor: Wesley Lin, Taichung Hsien (TW)

Correspondence Address: HARNESS, DICKEY & PIERCE, P.L.C., P.O. BOX 8910, RESTON, VA, 20195, US

(21) Appl. No.: 11/400,369

(22) Filed: Apr. 10, 2006

(51) Int. Cl. B62M 1/10

(52) U.S. Cl. 280/217

(57) ABSTRACT

A heavy-pedaling bicycle includes a pedaling unit which is rotated to deliver a driving force to drive a rear wheel to roll on a ground surface, and a dragging mechanism which is disposed on at least one of stationary and rotary members to generate a dragging force which counteracts the driving force during the forward pedaling of the pedaling unit, and which is self-adjustably maintained to be smaller than the driving force so as to turn the forward pedaling movement into an evenly decelerated movement. The dragging mechanism may include one of a plurality of wind blades, magnetically attractive members, and spring-biased friction members to generate a respective one of a resisting force, a magnetically attractive force, and a frictional force to serve as the dragging force.

### BACKGROUND OF THE INVENTION

1. Field of the Invention

This invention relates to a heavy-pedaling bicycle, more particularly to a heavy-pedaling bicycle which has a dragging mechanism that generates a dragging force to counteract a driving force generated by a forward pedaling action of a rider.

2. Description of the Related Art

Conventional bicycles are generally used as a means for transportation within a short distance, and thus can not provide sufficient exercise. For exercising purposes, the user may need to buy an indoor bicycle trainer which works by suspending the rear wheel of the bicycle off the ground, and providing resistance to the rear wheel through a resistance generating mechanism. However, such bicycle trainers are relatively expensive and inconvenient to install.

### SUMMARY OF THE INVENTION

The object of the present invention is to provide a heavy-pedaling bicycle which can generate a dragging force to counteract a driving force generated by a forward pedaling action so that more effort is required to pedal the bicycle forwards, thereby enabling the rider to have more exercise.

According to this invention, the heavy-pedaling bicycle includes a frame body elongated in a longitudinal direction, and front and rear wheels which are mounted to be rotatable relative to the frame body for rolling on ground, and which are spaced apart from each other in the longitudinal direction. A pedaling unit is mounted to be rotatable relative to the frame body such that upon pedaling forward by a rider, the pedaling unit is rotated about a pedaling axis transverse to the longitudinal direction to deliver a driving force in a clockwise direction to drive the rear wheel to roll on the ground. A stationary member is disposed on the frame body, and surrounds a rotating axis parallel to the pedaling axis. A rotary member is spaced apart from the stationary member in radial directions relative to the rotating axis, and is coupled to the pedaling unit so as to be driven by the driving force to revolve in the clockwise direction about the rotating axis relative to the stationary member, thereby driving the rear wheel to roll on the ground. A dragging mechanism is disposed on at least one of the stationary and rotary members, and is configured to generate during the movement of the forward pedaling, a dragging force which counteracts the driving force, and which is self-adjustably maintained to be smaller than the driving force so as to keep the forward pedaling on an evenly decelerated movement.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic side view of the first preferred embodiment of a heavy-pedaling bicycle according to this invention;

FIG. 2 is a fragmentary sectional view of a rear wheel structure shown in FIG. 1, taken along lines 2-2 thereof;

FIG. 3 is a fragmentary sectional view similar to FIG. 2, but showing the second preferred embodiment of the heavy-pedaling bicycle according to this invention;

FIG. 4 is a fragmentary sectional view similar to FIG. 2, but showing the third preferred embodiment of the heavy-pedaling bicycle according to this invention;

FIG. 5 is a fragmentary cross-sectional view taken along lines 5-5 of FIG. 4 and showing two friction arms in an engaging position;

FIG. 6 is a view similar to FIG. 5, but showing the friction arms in a disengaging position;

FIG. 7 is a schematic side view of the fourth preferred embodiment of the heavy-pedaling bicycle according to this invention;

FIG. 8 is a fragmentary sectional view of a pedaling unit structure shown in FIG. 7, taken along lines 8-8 thereof;

FIG. 9 is a cross-sectional view taken along lines 9-9 of FIG. 8;

FIG. 10 is a fragmentary sectional view similar to FIG. 8, but showing the fifth preferred embodiment of the heavy-pedaling bicycle according to this invention; and

FIG. 11 is a cross-sectional view taken along lines 11-11 of FIG. 10.

### DETAILED DESCRIPTION OF THE PREFERRED EMBODIMENTS

Before the present invention is described in greater detail, it should be noted that same reference numerals have been used to denote like elements throughout the specification.

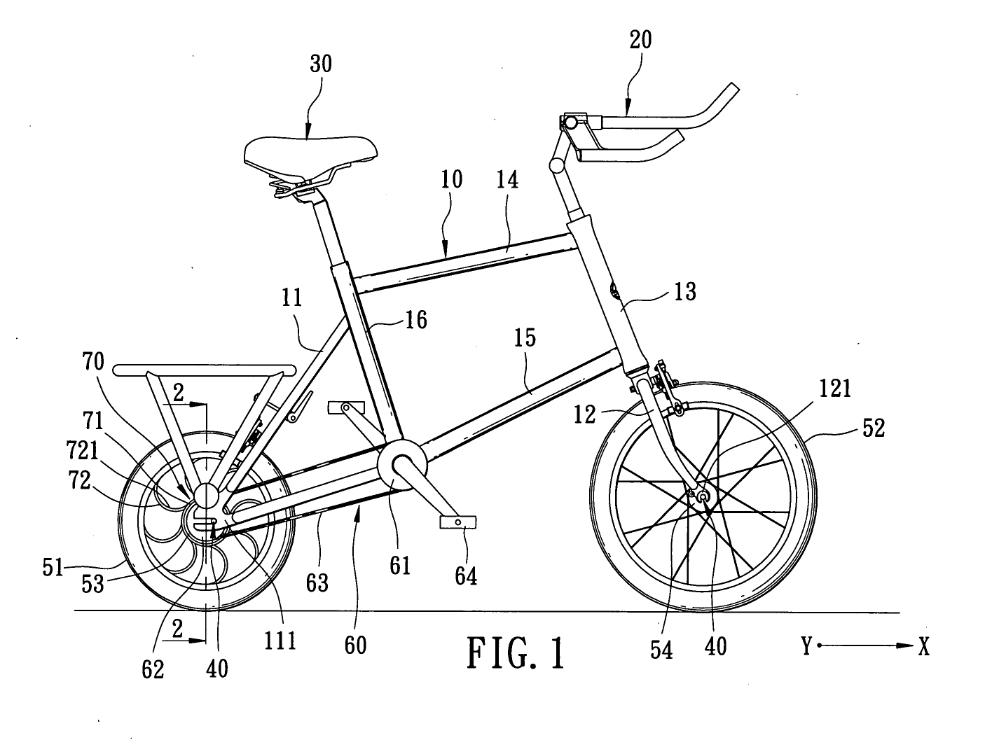

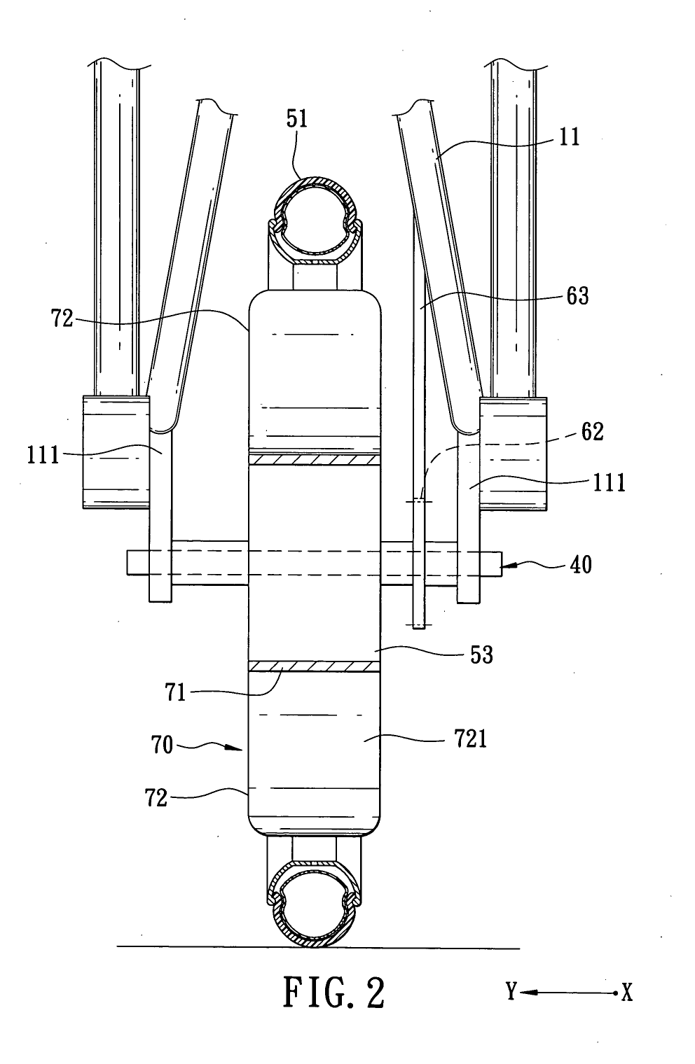

Referring to FIGS. 1 and 2, the first preferred embodiment of the heavy-pedaling bicycle according to the present invention is shown to comprise a frame body 10, a handle 20, a seat member 30, front and rear wheel axles 40, front and rear wheels 52,51, a driving mechanism 60, and a dragging mechanism 70.

The frame body 10 is elongated in a longitudinal direction (X), and includes front and rear forks 12,11, a head tube 13 connected to the front fork 12, top and down tubes 14, 15 connected to the head tube 13, a seat tube 16 connected to the top tube 14, and a bottom tube (not visible) connected to the rear fork 11, the down tube 15, and the seat tube 16. Each of the front and rear forks 12,11 has two fork ends 121,111 spaced apart from each other in a transverse direction (Y) relative to the longitudinal direction (X). The handle 20 is mounted on the head tube 13 to be controlled to steer the bicycle. The seat member 30 is mounted on the seat tube 16. The front and rear wheel axles 40 are each disposed between the fork ends 121,111 of the respective front and rear forks 12,11, and extend along rotating axes in the transverse direction (Y).

Front and rear wheel hubs 54,53 are spaced apart from the front and rear wheel axles 40, respectively, in radial directions relative to the respective rotating axes, and rotatably surround the front and rear wheel axles 40, respectively. The front and rear wheels 52,51 are connected to the front and rear wheel hubs 54,53, respectively, to be rotated therewith about the rotating axes for rolling on a ground surface, and are spaced apart from each other in the longitudinal direction (X).

The driving mechanism 60 includes front and rear chainwheel units 61,62 which are mounted to surround the bottom tube (not visible) and the rear wheel axle 40, a drive chain 63 which is trained on the front and rear chainwheel units 61,62, a pedaling unit 64 which is mounted to be rotatable relative to the bottom tube of the frame body 10, and a pedal shaft (not shown) which is coupled to and which is rotated with the pedaling unit 64 and which extends along a pedal axis parallel to the rotating axes. The driving mechanism 60 is coupled to the rear wheel hub 53 in a known manner. Thus, upon forward pedaling by a rider, the pedaling unit 64 is rotated about the pedaling axis to deliver a driving force in a clockwise direction through the front and rear chainwheel units 61,62 and the drive chain 63 so as to rotate the rear wheel hub 53 about the rotating axis, thereby driving the rear wheel 51 to roll on the ground surface.

In this embodiment, the rear wheel axle 40 serves as a stationary member, whereas the rear wheel hub 53 serves as a rotary member.

The dragging mechanism 70 includes a mounting ring 71 which is sleeved on the rear wheel hub 53, and a plurality of blades 72 which extend from the mounting ring 71 to the rear wheel 51 and which are angularly displaced from one another about the rotating axis. Each of the blades 72 extends in the transverse direction (Y) to form a lead major surface 721 such that when the blade 72 is turned clockwise with the rear wheel 51 and is located above the rotating axis, an air current is generated to act upon the lead major surface 721 to thereby generate a resisting force against the driving force that drives the rear wheel 51 to roll forwards. Preferably, the lead major surface 721 of each of the blades 72 has a width in the transverse direction (Y), which is larger than that of the rear wheel 51 such that the lead major surface 721 protrudes laterally of the rear wheel 51, and has a profile which is curved in the radial direction relative to the rotating axis so as to catch more wind, thereby generating an increased resisting force.

As illustrated, the dragging mechanism 70 can generate a dragging force (i.e. the resisting force) which counteracts the driving force during the forward pedaling. Moreover, the dragging force is self-adjustably maintained to be smaller than the driving force so as to result in evenly decelerated movement of the front and rear wheels 52,51. Hence, when riding the bicycle of the present invention, the rider needs to apply a large force in order to pedal the bicycle forward against the dragging force, thereby achieving the objective of exercising.

It is noted that the dragging mechanism 70 may also be mounted between the front wheel hub 54 and the front wheel 52.

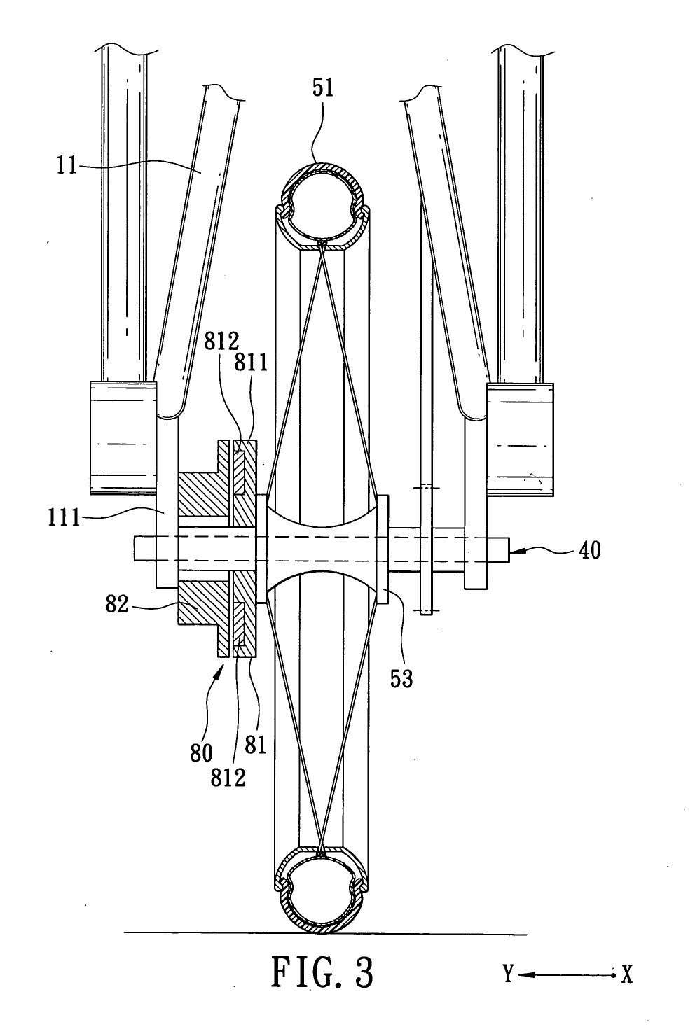

Referring to FIG. 3, the second preferred embodiment of the heavy-pedaling bicycle according to this invention is shown to be similar to the first preferred embodiment in construction, except that the dragging mechanism 80 includes first and second magnetically attractive members 81,82 which are disposed on the rear wheel hub 53 and one of the fork end 111, respectively, which confront and which are spaced apart from each other along the rotating axis, and which are magnetically attractive to each other so as to generate a magnetically attractive force during rotation of the rear wheel hub 53 to serve as the dragging force for counteracting the driving force. The first magnetically attractive member 81 includes a disc 811 which surrounds the rear wheel axle 40, and a plurality of magnets 812 which are mounted on a side face of the disc 811 and which are angularly displaced from one another about the rotating axis.

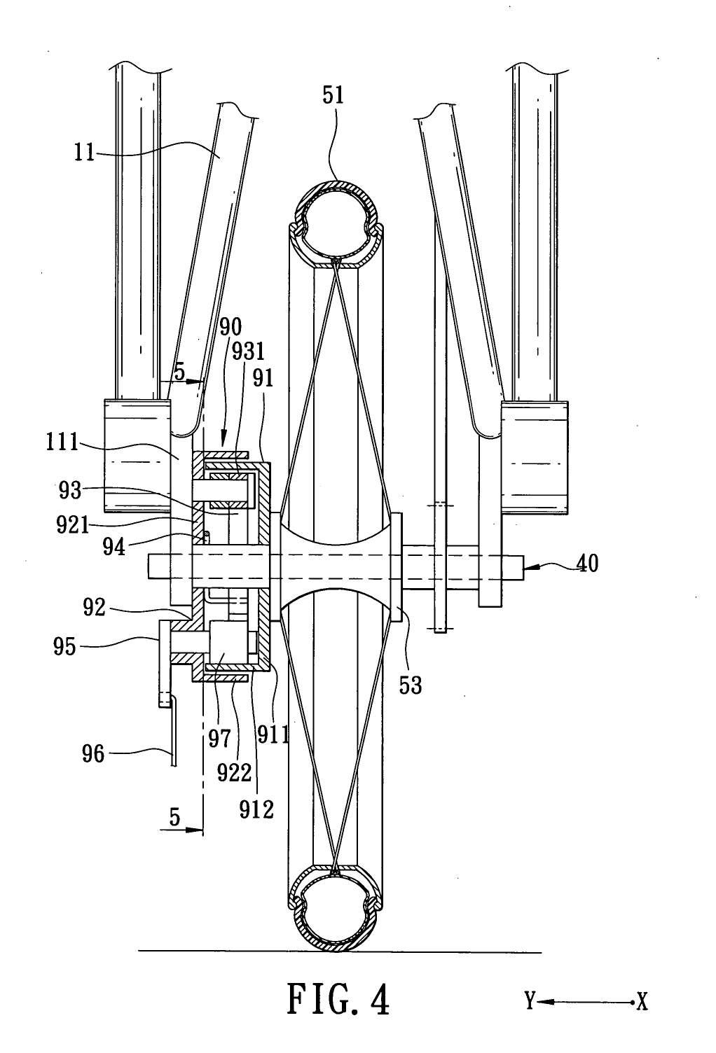

Referring to FIGS. 4 to 6, the third preferred embodiment of the heavy-pedaling bicycle according to this invention is shown to be similar to the first preferred embodiment in construction, except that the dragging mechanism 90 includes a rotating unit 91, a stationary unit 92, a pair of friction arms 93, a biasing member 94, and an actuating unit.

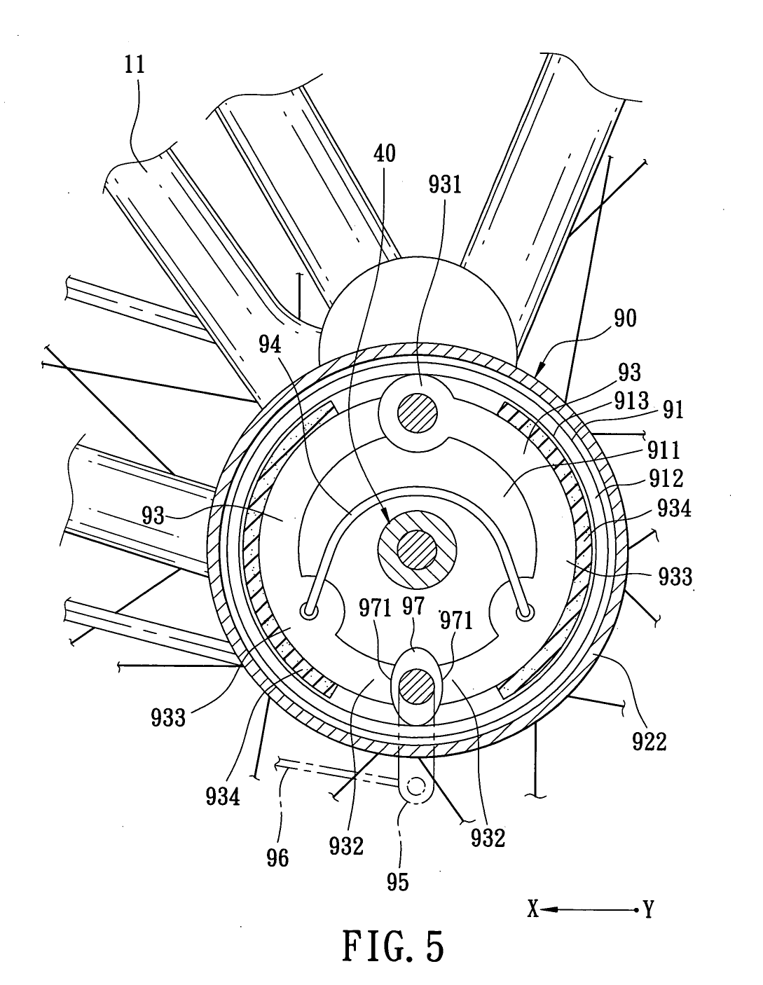

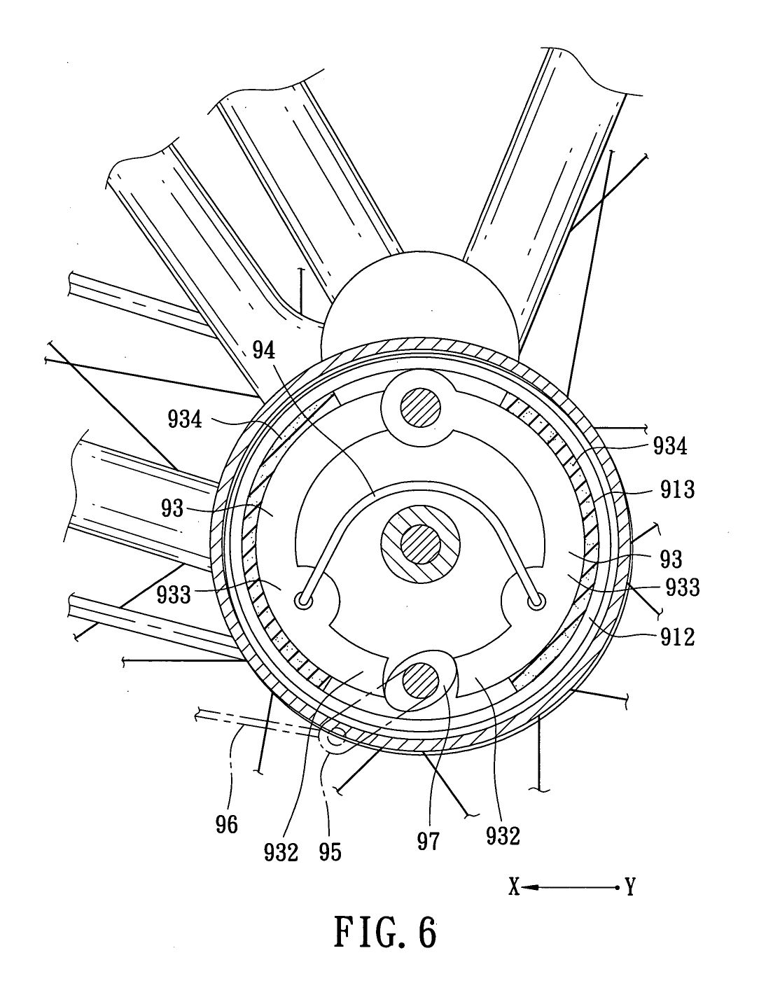

The rotating unit 91 includes a base wall 911 which is secured on and which is rotated with the rear wheel hub 53, and a surrounding wall 912 which extends from a periphery of the base wall 911 in the transverse direction (Y), and which has a surrounding friction surface 913 that surrounds and that is spaced apart from the rear wheel axle 40. The stationary unit 92 includes a base wall 921 which is secured on one of the fork ends 111, and a surrounding wall 922 which extends from a periphery of the base wall 921 in the transverse direction (Y) to be radially spaced apart from the surrounding wall 912. The friction arms 93 respectively have pivot ends 931 which are pivotally mounted on the base wall 921 about a pivot axis parallel to the rotating axis, and friction portions 933 which extend from the pivot ends 931 angularly about the rotating axis, which confront the surrounding friction surface 913, and which terminate at actuated ends 932 that confront and that are spaced apart from each other. Two friction pads 934 are attached to the friction portions 933, respectively. Thus, the friction portions 933 are turnable about the pivot axis between a disengaging position, as shown in FIG. 5, where the friction pads 934 are spaced apart from the surrounding friction surface 913, and an engaging position, as shown in FIG. 6, where the friction pads 934 are in yielding contact with the surrounding friction surface 913 so as to generate a frictional force to serve as the dragging force. The biasing member 94 is a spring strip having two biasing ends which engage the friction portions 933, respectively, and a middle portion which is interposed between the biasing ends and which is curved so as to acquire a biasing force to bias the friction portions 933 away from the surrounding friction surface 913 to the disengaging position.

The actuating unit includes a cam member 97, an operated member 95, and an actuating cable 96. The cam member 97 has two cam surfaces 971 which slidably contact the actuated ends 932, respectively. Each of the cam surfaces 971 is disposed to be slidable relative to a respective one of the actuated ends 932 between an actively-contacting position (as shown in FIG. 6) and a passively-contacting position (as shown in FIG. 5) that correspond to the engaging and disengaging positions, respectively. The cam member 97 is pivotally mounted to the base wall 921 about a cam axis parallel to the pivot axis. The operated member 95 is opposite to the cam member 97, and is operable to turn about the cam axis so as to move each of the cam surfaces 971 from the passively-contacting position to the actively-contacting position, thereby yieldingly actuating the actuated ends 932 to move the friction portions 933 to the engaging position against biasing action of the biasing member 94. The actuating cable 96 has a first cable end connected to the operated member 95, and a second cable end which is opposite to the first cable end, and which is mounted to the handle 20 (see FIG. 1 of the first embodiment) to be controlled by a rider. Thus, the rider can operate the actuating cable 96 to apply a frictional force to the rear wheel 51 as desired. Moreover, the frictional force can be adjusted by the rider.

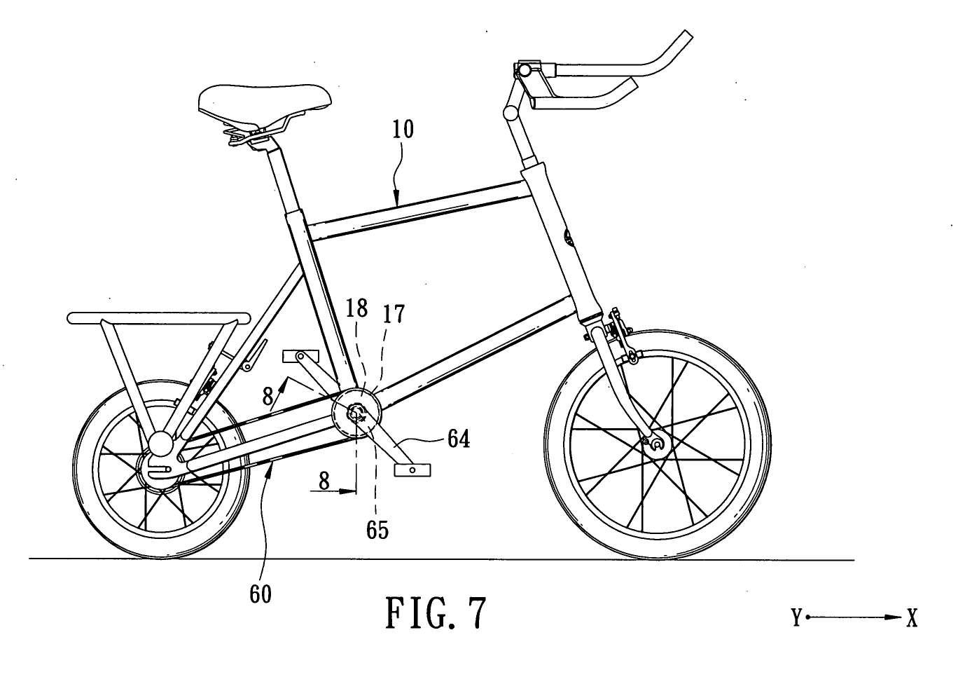

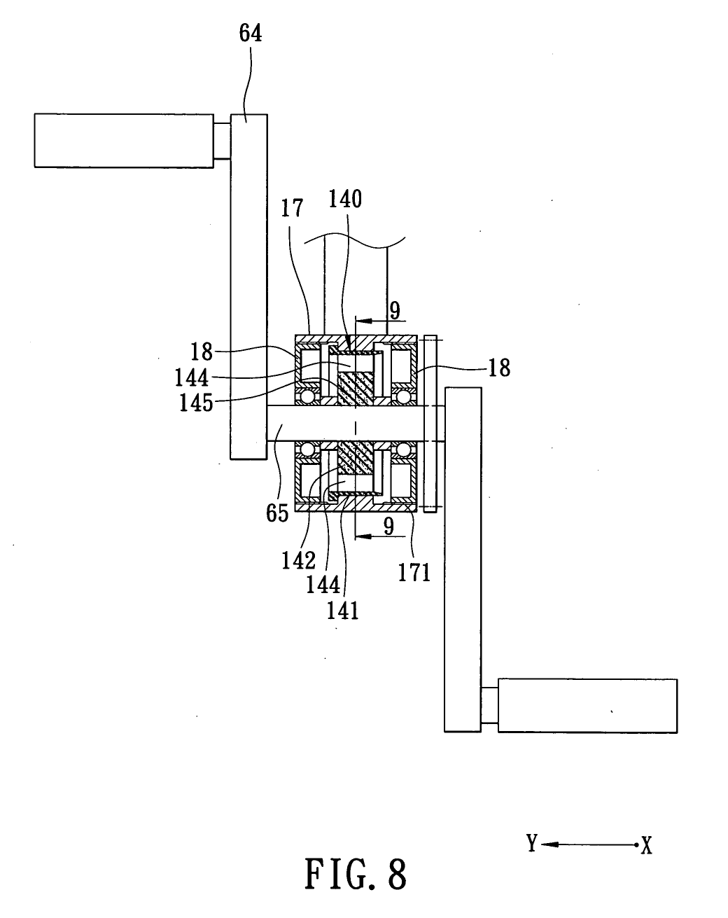

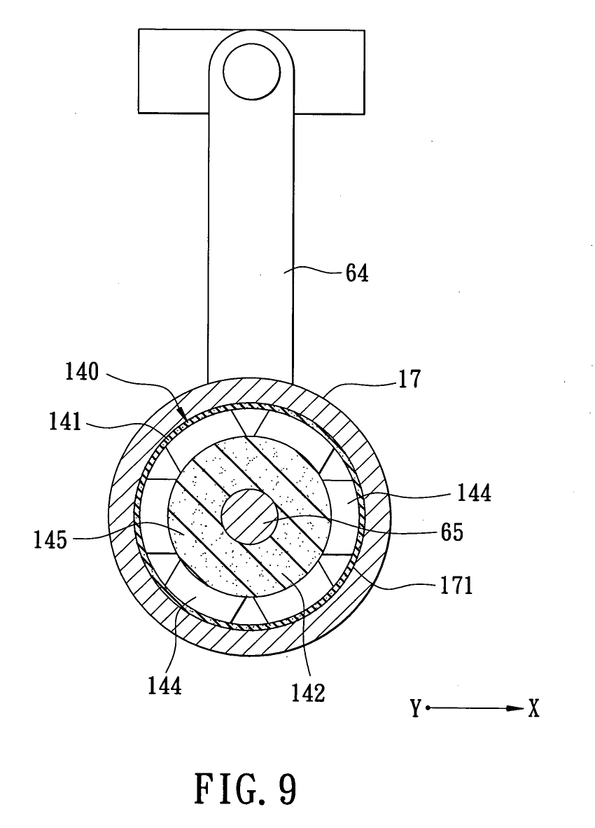

Referring to FIGS. 7 to 9, the fourth preferred embodiment of the heavy-pedaling bicycle according to this invention is shown to be similar to the first preferred embodiment in construction. In this embodiment, the pedal shaft 65 serves as the rotary member, and the bottom tube 17 serves as the stationary member, and has an inner surrounding tube surface 171 which is spaced apart from the pedal shaft 65 and which surrounds the pedaling axis.

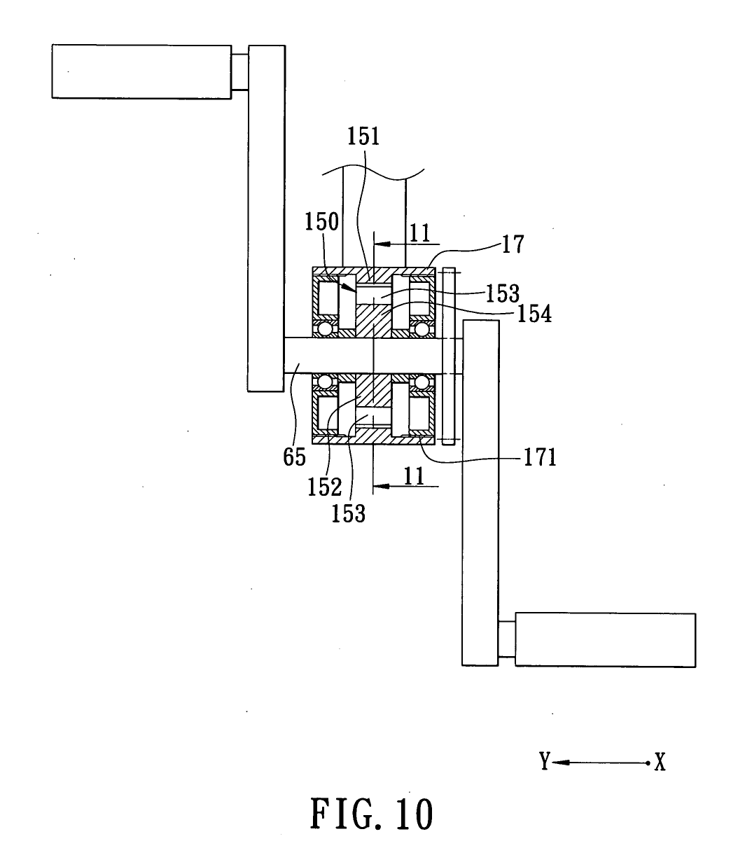

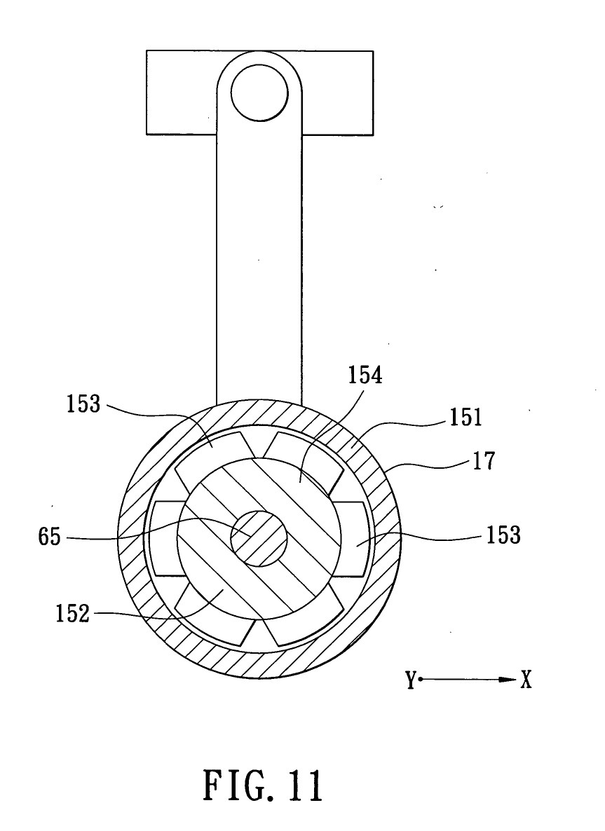

Moreover, in this embodiment, the dragging mechanism 140 is disposed between the bottom tube 17 and the pedal shaft 65, and is retained by two side covers 18. The dragging mechanism 140 includes a first friction member 141 which is securely disposed on the inner surrounding tube surface 171 and which surrounds the pedaling axis, and a second friction member 142 which is securely disposed on the pedal shaft 65, which is disposed inwardly of the first friction member 141 in radial directions relative to the pedaling axis, and which is configured to yieldingly contact the first friction member 141 so as to generate the dragging force to counteract the driving force. In particular, the second friction member 142 includes a deformable core body 145 which is mounted on and which is rotatable with the pedal shaft 65, and a plurality of friction pads 144 which are angularly displaced from one another about the pedaling axis and which are disposed to extend from the deformable core body 145 radially to be in frictional contact with the first friction member 141 such that, by virtue of deformability of the deformable core body 145 in a radial direction, the friction pads 144 are kept in yielding contact with the first friction member 141. Referring to FIGS. 10 and 11, the fifth preferred embodiment of the heavy-pedaling bicycle according to this invention is shown to be similar to the fourth preferred embodiment in construction, except that the dragging mechanism 150 includes first and second magnetically attractive members 151,152 which are disposed on the inner surrounding tube surface 171 and the pedal shaft 65, respectively, and which confront and which are spaced apart from each other in radial directions relative to the pedaling axis. The first and second magnetically attractive members 151,152 are magnetically attractive to each other so as to generate a magnetically attractive force during a rotation of the pedal shaft 65 to serve as the dragging force for counteracting the driving force. In particular, the first magnetically attractive member 151 is integrally formed with the bottom tube 17, and surrounds the pedaling axis. The second magnetically attractive member 152 includes a non-magnetic core body 154 which is mounted on and which is rotatable with the pedal shaft 65, and a plurality of magnets 153 which are angularly displaced from one another about the pedaling axis, which extend from the non-magnetic core body 154 radially, and which are spaced apart from the first magnetically attractive member 151.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A heavy-pedaling bicycle, comprising:
a frame body elongated in a longitudinal direction;
front and rear wheels which are mounted to be rotatable relative to said frame body for rolling on a ground surface, and which are spaced apart from each other in the longitudinal direction;
a pedaling unit which is mounted to be rotatable relative to said frame body and between said front and rear wheels in the longitudinal direction such that upon forward pedaling by a rider, said pedaling unit is rotated about a pedaling axis transverse to the longitudinal direction to deliver a driving force in a clockwise direction to drive said rear wheel to roll on the ground surface;
a stationary member disposed on said frame body, and surrounding a rotating axis which is parallel to said pedaling axis;
a rotary member which is disposed to be spaced apart from said stationary member in radial directions relative to the rotating axis, and which is coupled to said pedaling unit so as to be driven by the driving force to revolve in the clockwise direction about the rotating axis relative to said stationary member, thereby driving said rear wheel to roll on the ground surface; and
a dragging mechanism disposed on at least one of said stationary and rotary members, and configured to generate a dragging force which counteracts the driving force during the forward pedaling, the dragging force being self-adjustably maintained to be smaller than the driving force so as to result in evenly decelerated movement of said front and rear wheels.

2. The heavy-pedaling bicycle of claim 1, wherein said stationary member is a rear wheel axle which is secured to said frame body and which extends along the rotating axis such that said rear wheel is disposed to surround said rear wheel axle and is rotatable about the rotating axis,
said rotary member being a rear wheel hub which is disposed to rotatably surround said rear wheel axle so as to be driven by the driving force, thereby enabling said rear wheel to roll on the ground surface.

3. The heavy-pedaling bicycle of claim 2, wherein said dragging mechanism includes a plurality of blades which are disposed between said rear wheel hub and said rear wheel, and which are angularly displaced from one another about the rotating axis, each of said blades being configured to extend along the rotating axis to form a lead major surface such that when a corresponding one of said blades is turned clockwise with said rear wheel and is located above the rotating axis, an air current is generated to act upon said lead major surface to thereby generate a resisting force against the driving force that drives said rear wheel to roll forwards.

4. The heavy-pedaling bicycle of claim 3, wherein said lead major surface of each of said blades has a width along the rotating axis, which is larger than that of said rear wheel such that said lead major surface protrudes laterally of said rear wheel, and has a profile which is curved in the radial direction relative to the rotating axis so as to catch more wind, thereby generating an increased resisting force.

5. The heavy-pedaling bicycle of claim 2, wherein said dragging mechanism includes first and second magnetically attractive members which are disposed on said rear wheel hub and said frame body, respectively, which confront and which are spaced apart from each other along the rotating axis, and which are magnetically attractive to each other so as to generate a magnetically attractive force during a rotation of said rear wheel hub to serve as the dragging force for counteracting the driving force.

6. The heavy-pedaling bicycle of claim 5, wherein said first magnetically attractive member includes a plurality of magnets which are angularly displaced from one another about the rotating axis.

7. The heavy-pedaling bicycle of claim 2, wherein said dragging mechanism includes
a rotating unit which is secured on and which is rotated with said rear wheel hub, and which has a surrounding friction surface that surrounds and that is spaced apart from said rear wheel axle,
a stationary unit which is secured on said frame body,
a pair of friction arms respectively having pivot ends which are pivotally mounted on said stationary unit about a pivot axis parallel to the rotating axis, and friction portions which extend from said pivot ends angularly about the rotating axis, which confront said surrounding friction surface, and which terminate at actuated ends that confront and that are spaced apart from each other such that said friction portions are turnable about the pivot axis between a disengaging position, where said friction portions are spaced apart from said surrounding friction surface, and an engaging position, where said friction portions engage said surrounding friction surface so as to generate a frictional force to serve as the dragging force,
a biasing member which is disposed to bias said friction portions to the disengaging position, and
an actuating unit which is disposed to yieldingly actuate said actuated ends to move said friction portions to the engaging position against biasing action of said biasing member.

8. The heavy-pedaling bicycle of claim 7, wherein said actuating unit includes a cam member having two cam surfaces which slidably contact said actuated ends, respectively, each of said cam surfaces being disposed to be slidable relative to a respective one of said actuated ends between actively-contacting and passively-contacting positions that correspond to the engaging and disengaging positions, respectively, said cam member being pivotally mounted to said stationary unit about a cam axis parallel to the pivot axis, and
an operated member which is opposite to said cam member and which is operable to turn about the cam axis so as to move each of said cam surfaces from the passively-contacting position to the actively-contacting position, thereby resulting in turning of said friction portions to the engaging position.

9. The heavy-pedaling bicycle of claim 8, further comprising a handle which is controlled to steer said bicycle, said actuating unit further including an actuating cable which has a first cable end connected to said operated member, and a second cable end that is opposite to said first cable end, and that is mounted to said handle to be controlled by a rider.

10. The heavy-pedaling bicycle of claim 7, wherein said biasing member is a spring strip having two biasing ends which engage said friction portions respectively, and a middle portion which is interposed between said biasing ends and which is curved so as to acquire a biasing force to bias said friction portions away from said surrounding friction surface.

11. The heavy-pedaling bicycle of claim 7, wherein each of said friction portions has a friction pad which is attached thereto and which is configured such that in the engaging position, said friction pad is in yielding contact with said surrounding friction surface.

12. The heavy-pedaling bicycle of claim 1, wherein said rotary member is a pedal shaft which is coupled to and which is rotated with said pedaling unit, and which extends along the pedaling axis,
said stationary member being a bottom tube which is secured to said frame body, and which has an inner surrounding tube surface that is spaced apart from said pedal shaft and that surrounds the pedaling axis.

13. The heavy-pedaling bicycle of claim 12, wherein said dragging mechanism includes a first friction member which is securely disposed on said inner surrounding tube surface and which surrounds the pedaling axis, and a second friction member which is securely disposed on said pedal shaft, which is disposed inwardly of said first friction member in radial directions relative to the pedaling axis, and which is configured to yieldingly contact said first friction member to generate the dragging force to counteract the driving force.

14. The heavy-pedaling bicycle of claim 13, wherein said second friction member includes a deformable core body mounted on and rotatable with said pedal shaft, and a plurality of friction pads which are angularly displaced from one another about the pedaling axis and which extend from said deformable core body radially to be in frictional contact with said first friction member such that by virtue of deformability of said deformable core body in a radial direction, said friction pads are kept in yielding contact with said first friction member.

15. The heavy-pedaling bicycle of claim 12, wherein said dragging mechanism includes first and second magnetically attractive members which are disposed on said inner surrounding tube surface and said pedal shaft, respectively, and which confront and which are spaced apart from each other in radial directions relative to the pedaling axis, said first and second magnetically attractive members being magnetically attractive to each other so as to generate a magnetically attractive force during rotation of said pedal shaft to serve as the dragging force to counteract the driving force.

16. The heavy-pedaling bicycle of claim 15, wherein said first magnetically attractive member is integrally formed with said bottom tube, and surrounds the pedaling axis, said second magnetically attractive member including a non-magnetic core body which is mounted on and which is rotatable with said pedal shaft, and a plurality of magnets which are angularly displaced from one another about the pedaling axis, which extend from said non-magnetic core body radially, and which are spaced apart from said first magnetically attractive member.
